(19) United States
(12) Patent Application Publication
(10) Pub. No.: US 2017/0191228 A1
(43) Pub. Date: Jul. 6, 2017

(54) Anti-Icing Walkway with Integrated Control and Switching

(71) Applicant: Pentair Thermal Management LLC, Redwood City, CA (US)

(72) Inventor: Wesley Dong, Belmont, CA (US)

(21) Appl. No.: 15/398,587

(22) Filed: Jan. 4, 2017

Related U.S. Application Data
(60) Provisional application No. 62/274,691, filed on Jan. 4, 2016.

(51) Int. Cl. E01C 11/26; H05B 1/02

(52) U.S. Cl. CPC E01C 11/265; H05B 1/02

(57) ABSTRACT

A deicing cassette comprises a panel with a top and a plurality of sides, and the top and sides define an interior of the cassette. The top has an interior surface and an exterior surface serving as a walking surface. Additionally, a heating element is secured in thermal contact with the interior surface of the panel, and an integrated control system is disposed in the interior of the panel. The integrated control system comprises a temperature sensor exposed to the exterior of the panel, a power switching, device electrically connected to the heating element and electrically connecting to a power supply for providing power to the cassette, and a controller in electrical communication with the temperature sensor and the power switching device, the controller configured to operate the power switching devices to activate and deactivate power to the heating element based on a temperature read by the temperature sensor.

### CROSS-REFERENCE TO RELATED APPLICATIONS

This patent application is a non-provisional claiming priority to U.S. Prov. Pat. App. Ser. No. 62/274,691, of the same title, filed Jan. 4, 2016, and incorporated fully herein by reference.

### BACKGROUND

In sub-freezing climates, snow and ice accumulation on surfaces can cause injury to persons and property, affecting all types of structures that are exposed to the environment. In particular, roadways, driveways, sidewalks, and roofs and gutters of buildings are at risk of damage and can harbor dangerous conditions when covered in snow or ice. Additionally, there is significant risk associated with working, at certain worksites such as oil platforms and ships with exposed decks and passageways in freezing polar regions. Snow-melting and de-icing systems exist for applying heat to the snow and ice, or to the covered surfaces, referred to herein as “heated surfaces.” The thermal energy melts the snow and ice and reduces the associated hazards.

Several devices for generating the necessary thermal energy exist. While the systems of the present disclosure may utilize some or all known heat-generating devices, they are particularly applicable to control of heat tracing cables. Heat tracing cables have one or more electrical conductors or conductor arrangements that generate heat along the cable length when an electrical current is applied to the conductor(s). The cables are connected to one or more controllers that manage power application to the cables. Typically, controllers include or communicate with environmental sensors that are designed to detect when snow or ice is present and, therefore, when heat is needed.

Present heat tracing systems for walkway de-icing rely on a precipitation sensor that senses a drop in resistivity between a set of electrodes as the snow falls and/or ice forms on a heated surface. These systems are maintenance-intensive because the galvanic exposure of the sensing electrodes degrades the electrodes over time.

Traditional snow sensing systems using precipitation sensors can measure the onset of snow conditions effectively, but these systems often cannot detect when heat is no longer needed. This is because the sensors operate based on the presence of moisture in contact with or near the sensor itself. Even if snow or ice is melted from the immediate area around the sensor, it can still be present in other areas. Furthermore, with some types of presently used sensors, moisture will still be present in the form of water for a period of time, and the sensors will not “turn off,” thereby wasting energy. As a result, present systems are often configured to operate the heaters for fixed durations of time based on conservative estimates of the energy needed for the “worst-case-scenario” snow or ice conditions. The alternative would be risking unsafe conditions in case of insufficient heat, but the drawback is that more energy than necessary is almost always used. A system that can detect when the snow or ice has been sufficiently melted is needed.

Finally, ice melting systems on uninsulated passageways on ships and oil platforms are very difficult to control with remote sensors. Unlike an insulated object, the overall heat transfer coefficient of an uninsulated surface of a walkway is highly dependent on local wind speed thereby creating significant variance along a single passageway depending on each particular surface's exposure to wind. The present disclosure provides snow and ice melting systems for uninsulated surfaces using integrated sensing, control and switching, systems to provide better temperature control.

### SUMMARY

Embodiments of the present disclosure overcome the drawbacks of the previous systems and methods by providing system and methods that include a deicing cassette. The deicing cassette includes a panel having a top and a plurality of sides extending from the top. The top and sides define an interior of the cassette, the top having an interior surface facing the interior and an exterior surface opposite the interior surface and serving as a walking surface. The deicing cassette includes a heating element secured in thermal contact with the interior surface of the panel and an integrated control system disposed in the interior of the panel. The integrated control system includes a temperature sensor exposed to the exterior of the panel. The integrated control system further includes a power switching device electrically connected to the heating element and electrically connecting to a power supply for providing power to the cassette. Additionally, the integrated control system includes a controller in electrical communication with the temperature sensor and the power switching device. The controller operates the power switching devices to activate and deactivate power to the heating element based on a temperature read by the temperature sensor.

In another embodiment, a method for deicing a walking surface is disclosed. The method includes disposing a heating element in an interior of a cassette, the cassette having a top with an interior surface facing the interior and an exterior surface that forms at least a portion of the walking surface. The method additionally includes placing the heating element in thermal contact with the interior surface of the cassette and monitoring a temperature using a temperature sensor, where the temperature sensor is exposed to an exterior of the cassette. The method further includes determining a current temperature value using the temperature sensor and communicating the current temperature value to a controller. The controller is in electrical communication with the temperature sensor and a power switching device. The method includes providing power to the heating element and the cassette via the power switching device, and the power switching device is electrically connected to a bus wire. The method also includes activating and deactivating power to the heating element via the controller based on the current temperature value.

### DESCRIPTION OF THE DRAWINGS

FIG. 1 is a perspective view of a series of heat traced walkway cassettes, according to an embodiment.

FIG. 2 is a perspective view of a heat traced walkway cassette, in accordance with the present disclosure.

FIG. 3 is a partial close-up perspective view of the heat traced walkway cassette of FIG. 2.

FIG. 4 is a perspective view of the underside of the heat traced walkway cassette of FIG. 2.

FIG. 5 is a top perspective view of an embodiment of a heat traced walkway cassette in accordance with the present disclosure, shown with a partial cutaway of the top of the cassette panel.

FIG. 6 is a partial close-up perspective view of the heat traced walkway cassette of FIG. 5, showing the partial cutaway of the top of the cassette panel.

FIG. 7 is a partial close-up perspective view illustrating internal parts of the heat traced walkway cassette of FIG. 5.

FIG. 8 is a partial close-up perspective view of the heat traced walkway cassette of FIG. 2, with a partial cutaway of the top of the cassette panel showing the internal parts shown in FIG. 5.

FIG. 9 is a top perspective view of an embodiment of a heat traced walkway cassette in accordance with the present disclosure.

FIG. 10 is a schematic diagram of an embodiment of a heat traced walkway cassette in accordance with the present disclosure.

FIG. 11 is a schematic diagram of an embodiment of a heat traced walkway cassette in accordance with the present disclosure.

FIG. 12 is a schematic diagram of an embodiment of a heat traced walkway cassette in accordance with the present disclosure.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

The present disclosure may be used in certain environments, such as a ship. In one non-limiting example, the ship contains a variety of uninsulated surfaces, such as, decks, walkways, stairs and handrails, or other surfaces throughout the ship that are generally exposed to the elements. On a ship, or oil platform, even under nominal wind conditions, there may be many different local “microclimates” that occur due to different areas of the ship being exposed to direct wind, while other areas of the ship are protected from the wind. For example, a ship might have a heat transfer coefficient of 80 W/m²·K on its windward exposed surfaces, and a heat transfer coefficient of 5 W/m²·K on its leeward side exposed surfaces. These microclimates may result in drastically different heat transfer characteristics for the various uninsulated surfaces. Therefore, it is often very difficult to control ice melting systems especially when the surfaces are uninsulated, temperature sensors are not attached to the surfaces, and the temperature is controlled globally instead of locally. For example, if both the windward side and the leeward side are controlled from a single point controller, either one side will be excessively hot, or, alternatively, one side will not maintain the correct setpoint. Work environments such as a ship or an oil platform encounter extreme temperatures that quickly become hazardous when walkways and platforms are not adequately maintained free of ice and snow.

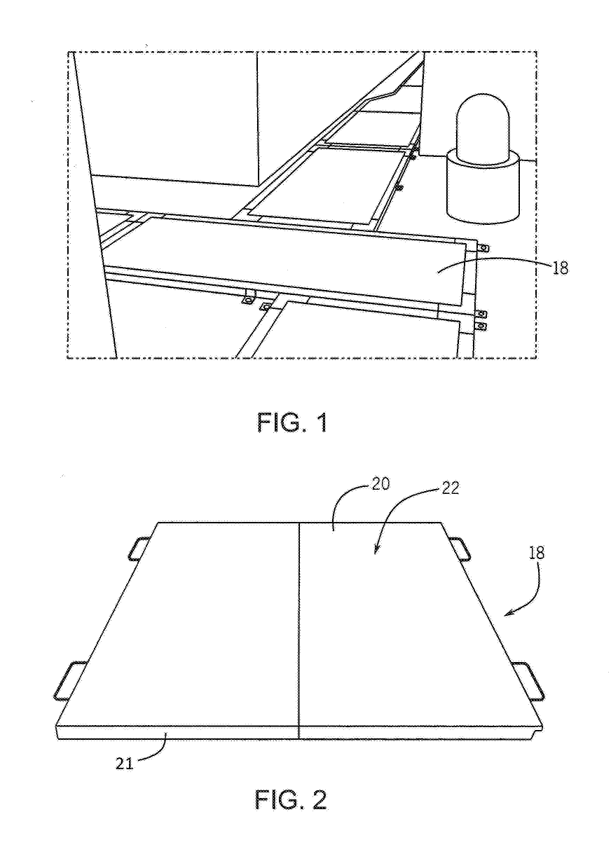

FIG. 1 shows a possible layout for a walkway formed by a plurality of heat traced walkway cassettes 18. The relatively portable size of the cassettes 18, measuring between about one and about three square meters in the non-limiting illustrated embodiments, allows for customized placement in existing walkways. This customization includes the ability to position the walkway cassettes 18 in a variety of different configurations, as shown in FIG. 1. In particular, the cassettes 18 may be placed in any suitable abutting configuration, forming a walkway with no gaps in between cassettes 18. For example, the cassettes 18 may be arranged so that all or a portion of at least one side of each cassette 18 abuts an adjacent cassette 18. Cassettes 18 in a walkway may have uniform or varying dimensions, as well as a general shape that is uniform or varies. The exemplary walkway cassette 18 has a generally rectangular perimeter, but circular trapezoidal, irregular, and other shapes are contemplated.

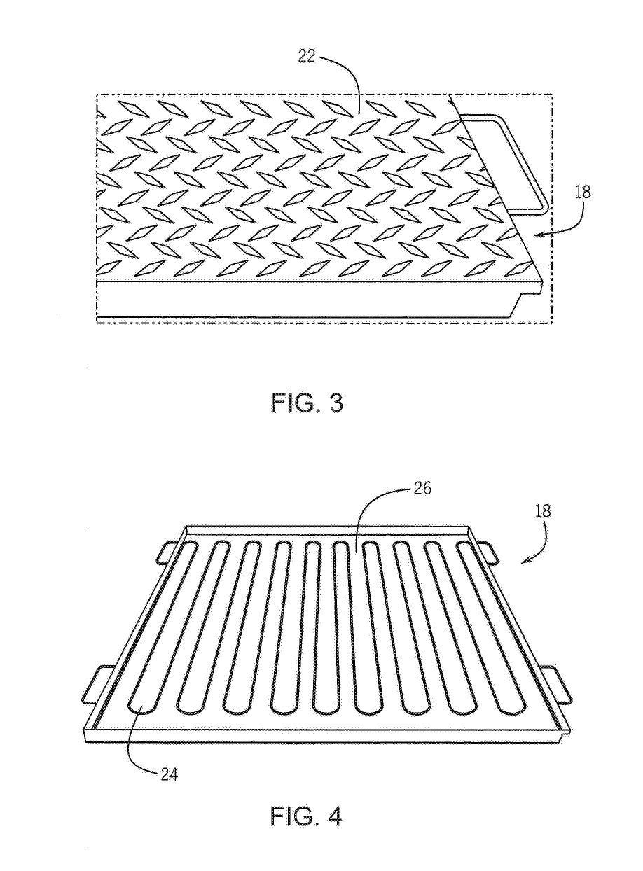

Referring to FIG. 2, in some embodiments the heat traced walkway cassette 18 may include a formed panel 20, typically, but not necessarily, made from formed sheet metal or an extruded profile. The formed panel 20 may include sides 21. The top of the formed panel 20 of the cassette 18, which may serve as the walking surface, may include a textured surface 22 to provide additional non-slip qualities to the walkway cassette 18. For example, FIG. 3 shows a close-up view of textured surface 22 of the formed panel 20 of the cassette 18. In certain embodiments, it may be beneficial to have a textured surface including a “diamond plate,” as shown in FIG. 3. In certain embodiments, it may be beneficial to manipulate the roughness of the textured surface 22 in order to control the level of convective heat transfer.

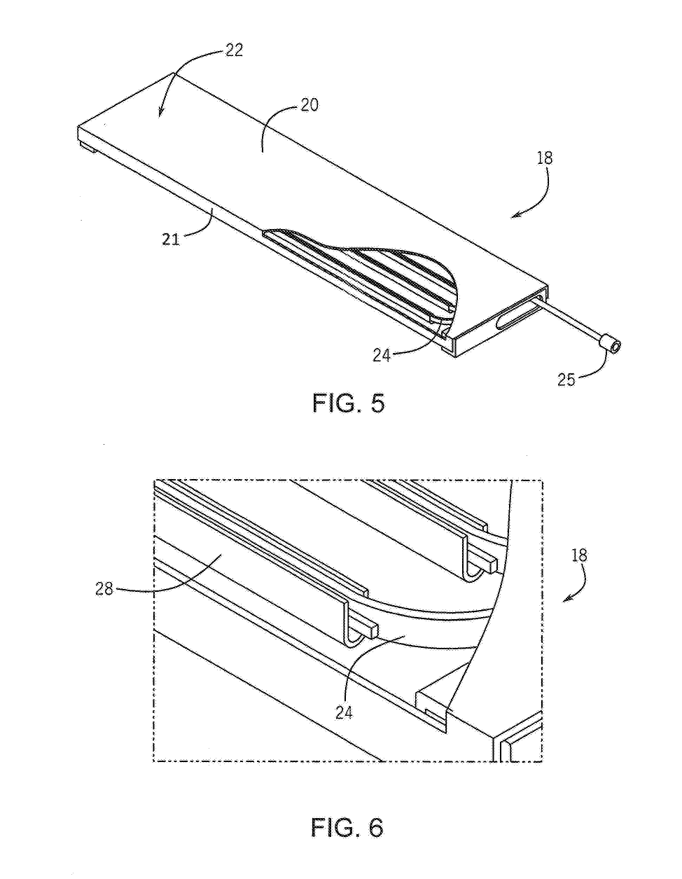

Referring to FIGS. 4 and 5, heat tracing cable 24 may be installed in thermal contact with the underside 26 of the panel 20 (i.e., the side opposite to the textured surface 22). Various positioning of the heat tracing cable 24 may be used, and may depend on the desired amount of heat transfer, cable properties such as heater type (e.g., self-regulating, constant wattage, hazardous environment rated, etc.), diameter and bend radius, type of power attachment, and size and material of the cassette 18. As illustrated, one advantageous arrangement may be a serpentine layout of the heat tracing cable 24. This arrangement may be used to provide uniform heating within the entire area of the cassette 18. Round and square spirals are other examples of suitable arrangements.

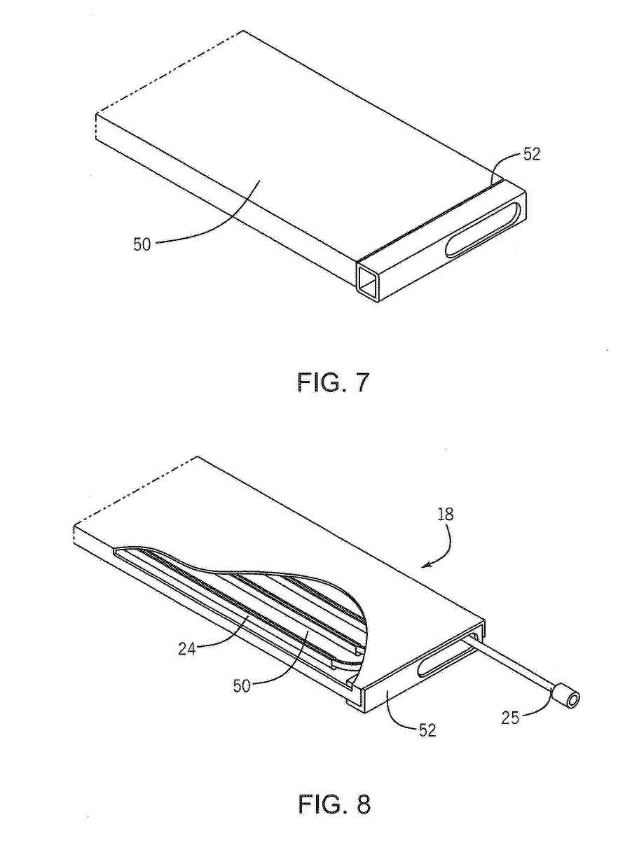

In some embodiments, the heat tracing cable 24 may be fastened in place with tape. The tape may be any suitable adhesive tape, but advantageously may include properties that improve heat transfer from the tracing cable 24 to the cassette 18, such as a high thermal conductivity. In one embodiment, the tape may be aluminum tape that helps improve heat transfer and minimize temperature gradients. The aluminum tape may become part of the grounding scheme of the cassette 18, which may allow the use of unshielded heating cable for the heat tracing cable 24. The use of unshielded heating cable would result in several improvements, including: improved heat transfer characteristics, a lighter weight for the cassette 18, and decreased manufacturing expense. Other mechanisms for adhesively or non-adhesively securing the heat tracing cable 24 to the cassette 18 may be used. In one embodiment, shown in FIG. 6, the heat tracing cable 24 may be installed in a serpentine fashion in thermal contact with the underside of the top of the panel 20 (i.e., with the interior surface 26 of FIG. 4) and fastened in place with clips 28.

The heat tracing cable 24 may be any suitable heater cable for heating a metal or other corrosion-resistant walkway panel in extreme environments. Thus, any heat tracing cable 24 with known applications in underfloor heating may be used, provided such heat tracing cable 24 has weather-resistant properties. Similarly, heat tracing cables 24 used in industrial heat tracing applications may be used, provided they have a suitable diameter, bend radius, and power requirements for use in the cassette 18. As described above, an unshielded heat tracing cable 24 may be used when aluminum tape or another component grounds the cassette 18. Alternatively, the heat tracing cable 24 may be chosen from existing shielded heating cables and may be self-regulating (e.g. Raychem BTV, Raychem QTVR, or similar), constant wattage (e.g. Raychem XPI or similar), or another suitable type of cable. Alternatively, in place of using a heat tracing cable 24 as the heating element, a pre-fabricated heating pad (e.g. silicone heating mat, or similar) may be used. Pre-fabricated heating pads may have some advantages over self-regulating cable in that inrush currents are less, and heat generation is closer to the surface that requires heat (i.e. the top surface of the cassette 18).

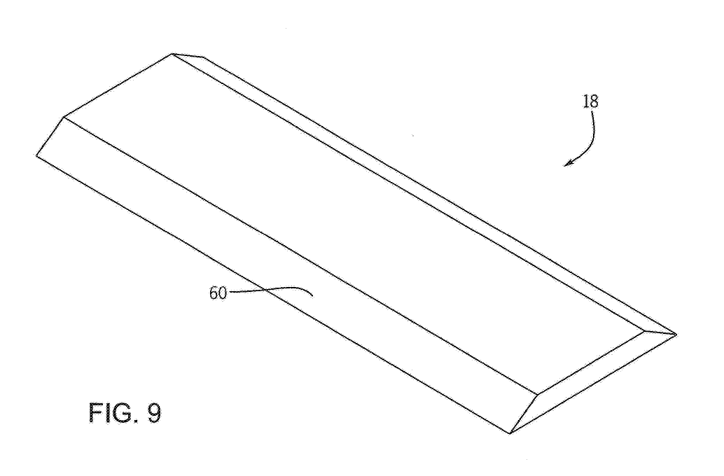

Thermal insulation may be factory installed to thermally insulate the cassette from the deck surface of the ship or platform, as well as from weather. Referring to FIG. 7, an insulation sheet 50 (e.g. foam or similar) may be added to thermally insulate the underside of the cassette 18. FIG. 8 shows the insulation sheet 50 inside the cassette 18, surrounding the heat tracing cable 24. Additionally, structural standoffs 52 that may be built into the ends of the cassette 18, can also act to isolate the cassette 18 from the underlying steel deck of the ship. The structural standoffs 52 may be, for example, made from a fiberglass material (e.g. a fiberglass tube or similar), or any insulating material that is rigid enough such that the insulation sheet 50 is not damaged when users walk on the cassette 18. The structural standoffs 52 may be glued or bolted to the underlying steel decking of the ship in order to fasten the cassette 18 in place. The cassette 18 may be formed in one of several ways. In one embodiment, the entire cassette 18 may be formed from sheet metal which is bent and/or molded into shape. The structural standoffs 52 may be added for structural strength. In another embodiment, a box may be formed by folding four sides down from the top piece of the cassette 18 and then welding the vertical edges to seal the box on five sides. In another embodiment, a bottom may be provided to seal the box on six sides. In yet another embodiment, the shape of the cassette 18 may have angled sides 60 in order to reduce the likelihood of users tripping on the edges, as shown in FIG. 9.

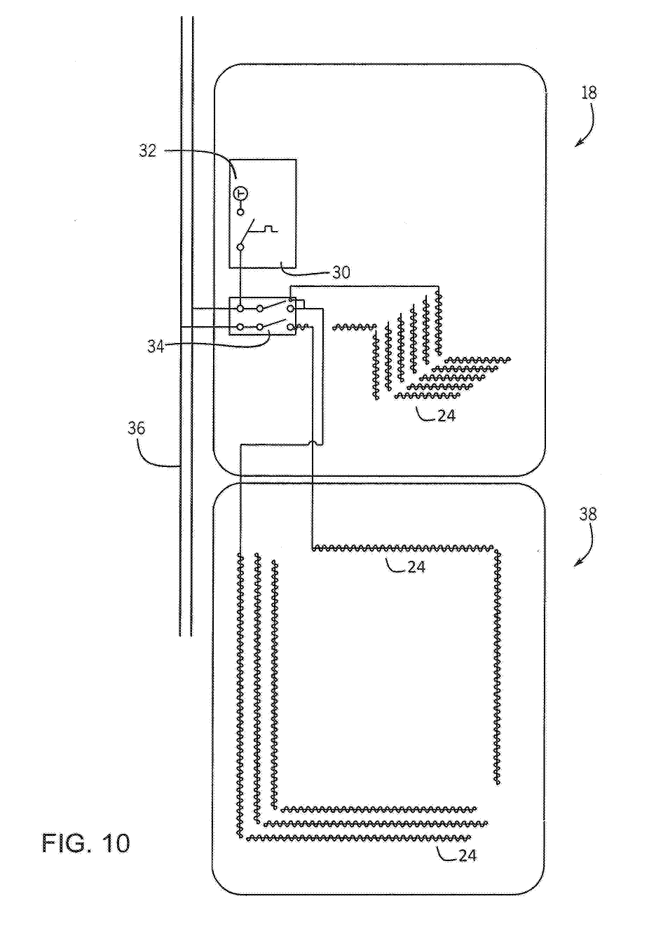

Referring to FIG. 10, regardless of what type of heating element is used, for example a heat tracing cable 24 or a pre-fabricated heating pad, the heating element is electrically connected to an electronic subsystem that senses the temperature of cassette 18, and controls the powering of the heating cable 24 or pre-fabricated heating pad based on a temperature setpoint. In addition to the elements described above, such as the formed panel 20 and the heat tracing cable 24, the heat traced walkway cassette 18, may also comprise a standalone temperature control 30, integrated temperature sensor 32, and power switching device 34. The standalone temperature control 30 may include a printed circuit board assembly (PCBA) which, based on the state of the integrated temperature sensor 32, either causes the power switching device to provide or cut power to the heat tracing cable 24. For example, if the desired temperature setpoint is set at three degree Celsius (+3° C.), at temperatures below +3° C. the integrated temperature sensor 32 would communicate to the temperature control 30 that power should be supplied to the heat tracing cable 24. The temperature control 30 would in turn cause the power switching device 34 to provide power from power lines 36 to the heat tracing cable 24. Additionally, the standalone temperature control 30 may include integrated over-temperature protections. For example, the temperature control 30 may include a separate temperature sensor, a latching bimetallic over-temperature switch, thermal fuses, or the like. These over-temperature protection devices can prevent the cassette 18 from overheating and causing potential damage.

As described above, a ship or oil platform may have numerous microclimates, which may result in drastically different heat transfer characteristics for the various uninsulated surfaces. For example, a ship might have heat transfer coefficient of 80 W/m²·K on its windward exposed surfaces, and a heat transfer coefficient of 5 W/m²·K on its leeward side exposed surfaces. Therefore, in the above described situation, the windward side might require 1600 W/m² to remain at the prescribed temperature, and only 100 W/m² on the leeward side. If both sides are controlled from a single point controller, either one side will be excessively hot, or the other side will not maintain the correct setpoint. Because the integrated temperature sensor 32 is located directly on the cassette 18, superior temperature control is possible. The cassettes 18 in each different zone or microclimate can each be controlled independently. Energy may be saved, and the cassettes 18 on the entire ship operate at the correct setpoint rather than some cassettes being hot and wasting energy, while other cassettes are cold, which results in the failure of the anti-icing intent.

The power switching device 34 may be any suitable electrical current switch, such as a solid-state relay (SSR). SSRs respond to an appropriate input control signal and switch power to a load circuitry. In this case, if the power switching device 34 is a SSR it receives the input control signal from the temperature control 30 and switches power from a large-gauge high-current bus 36 to the heat tracing cable 24, or other heating element. SSRs used for high current switching may result in current/voltage loss in the form of heat generation. In one embodiment, the SSR employed as the power switching device 34 may be heat sinked to the cassette 18 itself. In this configuration, the current/voltage losses in the SSR actually contribute to the anti-icing capability of the cassette 18.

The heat traced walkway cassettes 18 may be powered by a large-gauge high-current bus 36 with parallel wiring, as opposed to series wiring. The parallel wiring of the cassettes 18 reduces the voltage drop that would occur if the cassettes 18 were powered in series, and results in fewer power points. Also as a result of the parallel wiring, cassettes 18 that are connected further away from a power point will perform as well as cassettes 18 that are connected close to a power point. Additionally, the number of cassettes 18 is not limited by the voltage drop that occurs down the heating cable bus wires as occurs with series wiring, but rather the number of cassettes 18 would be limited by the applicable circuit breaker sizing associated with the large-gauge high-current bus 36. While the high-current bus 36 is advantageous, typical series power wiring may also be used if warranted by the application.

In another embodiment, the control system of the cassette 18 may be electrically connected to a heat traced walkway cassette 38 that does not have integrated control or switching, as shown in FIG. 10. The control system of the cassette 18 may also control the cassette 38 that has no integrated controls. The cassette 18 with the integrated control and switching may be joined to the cassette 38 without integrated control or switching in a head to tail fashion by means of a weatherproof plug 25, shown in FIG. 5. Alternatively, it is also contemplated that the cassettes 18 that each contain the integrated control and switching may be joined in a head to tail fashion by means of the weatherproof plug 25.

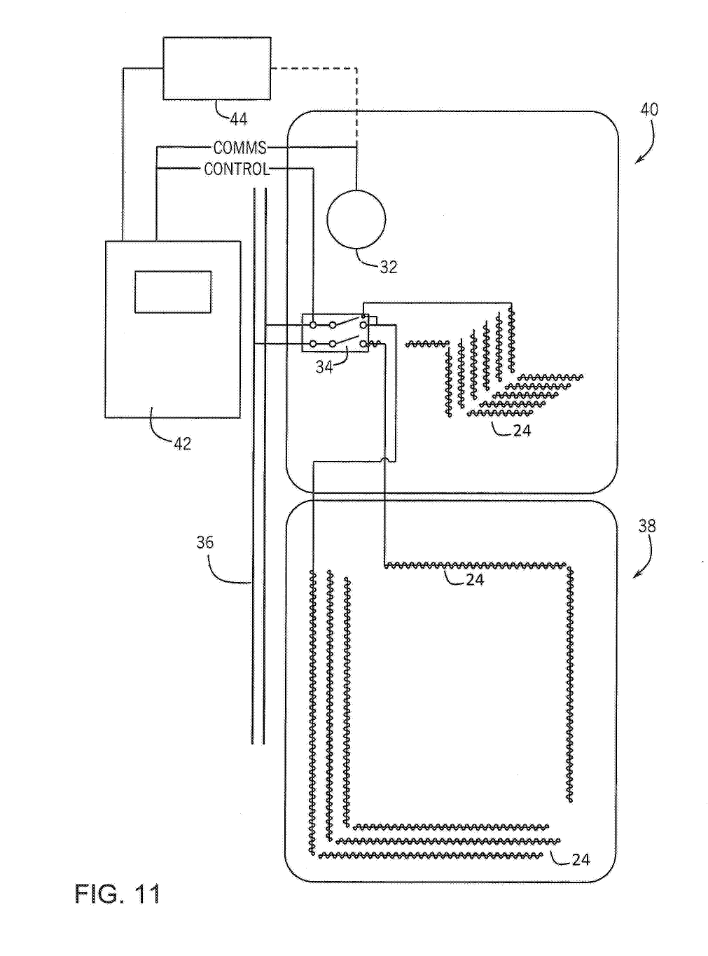

In yet another embodiment, shown in FIG. 11, a heat traced walkway cassette 40 with integrated temperature sensing and power switching may be used. This cassette 40 may not have the integrated temperature control, but rather may be controlled by means of a multi-circuit electronic control, monitoring, and power distribution system 42 (e.g. Raychem NGC-30—“Advanced Heat-Tracing Control System” or similar). The cassette 40 may comprise an integrated temperature sensor 32, and a power switching device 34. As with the embodiment described with reference to FIG. 10, the cassette 40 can still be controlled independently as the temperature sensor 32 would communicate to the multi-circuit electronic control, monitoring, and power distribution system 42 to indicate when power should be supplied to the heat tracing cable 24. The multi-circuit electronic control, monitoring, and power distribution system 42 would in turn cause the power switching device 34 to provide power to the heat tracing cable 24. Self-regulating heating cables experience an increase in voltage drop due to increasing cable length. FIG. 10 illustrates an added benefit of having each cassette 40 with a separate parallel circuit. Using this configuration, there is a minimized concern of incurring large voltage drops when using self-regulating heating cables.

The communication between the temperature sensor 32 and the multi-circuit electronic control, monitoring, and power distribution system 42 may be made through a remote monitoring module 44 (e.g. Raychem RMM2 or similar). The use of a remote monitoring module 44 would aggregate the input from multiple different temperature sensors 32 and communicate the information to the multi-circuit electronic control, monitoring, and power distribution system 42. This simplifies the wiring required when using a multi-circuit electronic control, monitoring, and power distribution system 42 in place of a standalone temperature control 30.

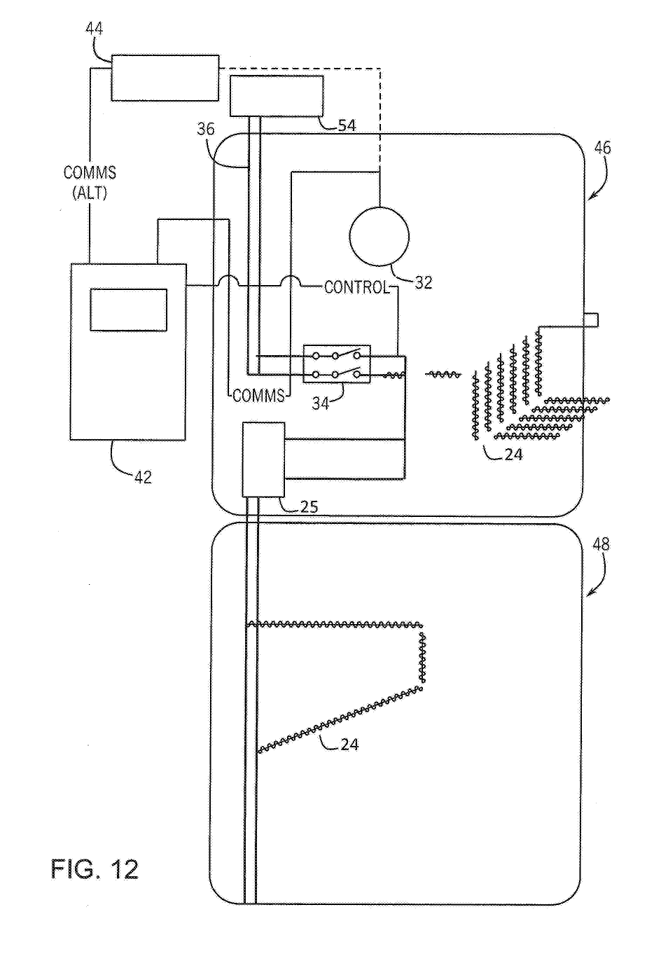

As described above, the cassettes 18 may be joined in a head to tail fashion, as in FIG. 12. In one embodiment, a “master” cassette 46 may have the integrated temperature sensing and power switching. A “slave” cassette 48 may not have the integrated temperature sensing or the power switching. Instead, the master cassette 46 may include an output such as, for example, a bulkhead mounted socket that is able to receive a plug. Accordingly, the slave cassette 48 may include an input such as, for example, a plug that is able to connect to the bulkhead mounted socket of the master cassette 46. For ease of installation and use, a cord may be coupled to the plug. The slave cassette 48 may further include a bulkhead mounted socket that is able to receive a plug from another slave cassette 48. Therefore, multiple slave cassettes 48 can be powered from a single master cassette 46. In this embodiment, all internal cassette wiring may be done prior to installation. The head to tail plug-in functionality may result in faster installation times. In some instances, it may be beneficial to have up to five slave cassettes 48 powered from a single master cassette 48. It is important to note that connecting a master cassette 46 to the output of a slave cassette 48 will not result in the same functionality. In effect, this merely causes the master cassette 46 to be dependent upon the power state of the slave cassette 48.

The previously described switching and control elements of the cassette 18 need to be very well sealed from the environment (e.g. potted in resin) to assure long term durability in the environment. It is expected that the entire cassette 18 will be exposed to water, and thus any electrical connections must be sufficiently sealed to survive immersion in water without compromising control, for example, the control connection and heat trace cable may be connected with an IP67 or IP68 seal (or approximate NEMA equivalent). Similarly, any other plugs or sockets used on the system will need to be IP68 rated as well (or approximate NEMA equivalent).

In the present disclosure a number of example embodiments are presented with reference to a walkway cassette. It will be appreciated, however, that the integrated control, temperature sensing, and power switching configurations disclosed herein may be applicable and incorporated into other types of exposed uninsulated surfaces, such as decks, stairs, handrails, and the like.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. Various features and advantages of the invention are set forth in the following claims.

What is claimed is:

1. A deicing cassette comprising:
a panel having, a top and a plurality of sides extending from the top, the top and sides defining an interior of the cassette, the top having an interior surface facing the interior and an exterior surface opposite the interior surface and serving as a walking surface;
a heating element secured in thermal contact with the interior surface of the panel; and
an integrated control system disposed in the interior of the panel and comprising:
a temperature sensor exposed to the exterior of the panel;
a power switching device electrically connected to the heating element and electrically connecting to a power supply for providing power to the cassette; and
a controller in electrical communication with the temperature sensor and the power switching device, the controller configured to operate the power switching devices to activate and deactivate power to the heating element based on a temperature read by the temperature sensor.

2. The deicing cassette of claim 1 further comprising thermal insulation to thermally insulate the cassette from an underlying surface on which the cassette is placed to form a walkway.

3. The deicing cassette of claim 2, wherein the thermal insulation is comprised of one or more structural standoffs coupled to the panel and independently coupleable to the underlying surface to form the walkway.

4. The deicing cassette of claim 1, wherein the exterior surface is textured and one or more of the plurality of sides extend from the top at an oblique angle to the exterior surface.

5. The deicing cassette of claim 1, wherein the heating element is a heat tracing cable.

6. The deicing cassette of claim 5, wherein the heat tracing cable is a self-regulating heating tracing cable.

7. The deicing cassette of claim 5 wherein the heat tracing cable is unshielded and is secured in thermal contact with the interior surface of the panel using conductive adhesive tape that aids in grounding the heat tracing cable.

8. The deicing cassette of claim 5, wherein the heat tracing cable is secured in thermal contact with the interior surface of the casing using clips.

9. The deicing cassette of claim 1, wherein the heating element is a pre-fabricated heating pad.

10. The deicing cassette of claim 1, wherein the power switching device is coupled to the panel and used as a heat sink.

11. The deicing cassette of claim 1, further comprising:
an input plug for electrically connecting the cassette to the power supply; and
an output port electrically connected to the input plug.

12. The deicing cassette of claim 11, wherein the input plug is configured to connect to a corresponding output port of a first adjacent deicing cassette and the output port is configured to connect to a corresponding input plug of a second adjacent deicing, cassette, the deicing cassette electrically connecting to the first adjacent deicing cassette and to the second adjacent deicing cassette to form a walkway.

13. The deicing cassette of claim 12, wherein the deicing cassette receives power from the first adjacent deicing cassette and provides power to the second adjacent deicing cassette.

14. The deicing cassette of claim 12, wherein the controller controls a power switching of the second adjacent deicing cassette.

15. The deicing cassette of claim 1, further comprising an over-temperature protection device that prevents the cassette from overheating.

16. A method for deicing a walking surface, the method comprising:
disposing a heating element in an interior of a cassette, the cassette having a top with an interior surface facing the interior and an exterior surface that forms at least a portion of the walking surface;
placing the heating element in thermal contact with the interior surface of the cassette;
monitoring a temperature using a temperature sensor, the temperature sensor exposed to an exterior of the cassette;
determining a current temperature value using, the temperature sensor;
communicating the current temperature value to a controller, the controller in electrical communication with the temperature sensor and a power switching device;
providing power to the heating element and the cassette via the power switching device, the power switching device electrically connected to a bus wire; and
activating and deactivating power to the heating element via the controller based on the current temperature value.

17. The method of claim 16 wherein the controller, the power switching device, and the temperature sensor are disposed in the interior of the cassette.

18. The method of claim 16 further comprising communicating the current temperature value to the controller via a remote monitoring module, the remote monitoring module configured to aggregate current temperature values from multiple temperature sensors.

19. The method of claim 18, further comprising the remote monitoring module communicating current temperature values to a multi-circuit electronic control, monitoring, and power distribution system.

20. The method of claim 16 further comprising the controller activating power to the heating element when the current temperature value is less than a predetermined temperature setpoint.
